(19) United States
(12) Patent Application Publication
(10) Pub. No.: US 2007/0110628 A1
(43) Pub. Date: May 17, 2007

(54) Apparatus and method for dispensing fractions of an analyte solution

(75) Inventor: Alexandre Loboda, Toronto (CA)

Correspondence Address: TORYS LLP, 79 WELLINGTON ST. WEST, SUITE 3000, TORONTO, ON, M5K 1N2, CA

(73) Assignee: MDS Inc., doing business as MDS Sciex, Ontario (CA)

(21) Appl. No.: 10/555,784

(22) PCT Filed: May 28, 2004
(86) PCT No.: PCT/CA04/00792

§ 371 Date: Jan. 23, 2007

Related U.S. Application Data
(60) Provisional application No. 60/473,932, filed on May 29, 2003.

(51) Int. Cl. B01L 3/02

(52) U.S. Cl. 422/100

(57) ABSTRACT

An apparatus and method for dispensing low volumes of an analyte solution. The apparatus comprises: (a) a receiver defining an ejection cavity and an outlet downstream of and in fluid communication with the ejection cavity; (b) first and second fluid conduits coupled to the receiver and defining respective first and second fluid flow paths in fluid communication with the ejection cavity; (c) an analyte generating apparatus operatively coupled to the first fluid conduit and operable to deliver analyte solution along the first fluid flow path to the ejection cavity; and (d) a dispensing mechanism operatively coupled to the second fluid conduit and operable to deliver a fluid buffer along the second fluid flow path into the ejection cavity to displace analyte solution present therein through the outlet. The method involves filling the ejection cavity with an analyte solution at a selected rate and injecting a fluid buffer into the injection cavity to displace the analyte solution through the outlet.

### FIELD OF THE INVENTION

The present invention relates to an apparatus and method for dispensing low volumes of an analyte solution for subsequent testing or analysis.

### BACKGROUND OF THE INVENTION

Apparatus used in analytical chemistry include mass spectrometers. One type of mass spectrometer is a matrix assisted laser desorption ionization (MALDI) mass spectrometer of which there are also several types. MALDI is typically operated as an off-line ionization technique, where a solid or liquid sample, mixed with a suitable matrix, is deposited on a MALDI target or medium to form dry mixed crystals and, subsequently, placed in a source chamber of the mass spectrometer for analysis. An example of a MALDI target is a rectangular plate having a plurality of microfabricated wells on an upper surface thereof for receiving pL-nL sample volumes of analyte solution. The analyte solution may be generated by a variety of separation or processing techniques or apparatus including liquid chromatography apparatus.

Liquid chromatography (LC) involves the separation of chemical substances and particles by differential movements through a two phase system. A mixture of materials is typically applied to a column containing a suitable chosen absorbent (e.g. an ion-exchange material) and caused to flow therethrough. Materials in the mixture are absorbed at differential rates, with the least absorbed materials emerging first from the column and the more strongly absorbed materials emerging later.

When analyzing liquids eluted from an LC apparatus using a mass spectrometer, it is important to dispense very low volume samples (e.g. pL-nL samples) with no or minimal carry-over. That is, it is desirable to keep the components of a sample as well as the components of subsequent samples from mixing together when being deposited on a sample target or medium. While apparatus and methods exist for dispensing low volumes of liquid, there is a problem with carryover of liquid samples being dispensed. The present invention is intended to address this problem.

### SUMMARY OF THE INVENTION

In accordance with a first aspect of the invention, there is provided an apparatus for dispensing fractions of an analyte solution, the apparatus comprising:
(a) a receiver defining an ejection cavity and an outlet downstream of and in fluid communication with the ejection cavity;
(b) first and second fluid conduits coupled to the receiver and defining respective first and second fluid flow paths in fluid communication with the ejection cavity;
(c) an analyte generating apparatus operatively coupled to the first fluid conduit and operable to deliver analyte solution along the first fluid flow path to the ejection cavity;
(d) a dispensing mechanism operatively coupled to the second fluid conduit and operable to deliver a fluid buffer along the second fluid flow path into the ejection cavity to displace analyte solution present therein through the outlet.

The ejection cavity may have a volume of between 0.1 nl and 1000 nl, or less than 500 nl, 200 nl, 100 nl, or 50 nl.

The dispensing mechanism may comprise an actuator chosen from solenoid, piezoelectric, electro kinetic, mechanical, valve, thermal, magnetic, and pressurized fluid actuators. Furthermore, the analyte generating apparatus may comprise a component chosen from liquid chromatography, capillary electrophoresis, and capillary electro chromatography apparatus.

The dispensing mechanism may further include an aspirator operable to selectively reverse the flow of buffer from and out of the ejection cavity and upstream along the second fluid conduit.

The outlet of the apparatus may be circular and have a diameter of from 5 to 200 micrometers, or less than 100, 50, or 20 micrometers.

In one embodiment, the apparatus is used to dispense fractions of an analyte solution onto a collection medium for subsequent testing by matrix assisted laser desorption ionization, and includes a matrix flow generator, the matrix flow generator having a matrix supply and a third conduit having a first end in communication with the matrix supply and a second end in communication with the ejection cavity, the matrix flow generator being operable to deliver matrix through the third conduit to the ejection cavity, whereby a mixture of the analyte solution and matrix is dispensed when the dispensing mechanism is actuated. The second end of the third conduit may be in communication with the first flow path upstream of the ejection cavity whereby mixing of the matrix and analyte may occur upstream of the ejection cavity.

In accordance with another aspect of the invention, there is provided a method for dispensing fractions of an analyte solution comprising the steps of:
(a) providing a receiver defining an ejection cavity and an outlet in communication with and downstream of the ejection cavity;
(b) filling the ejection cavity with an analyte solution at a selected rate; and
(c) injecting a fluid buffer into the ejection cavity to displace the analyte solution through the outlet.

The analyte solution may be eluted material exiting a liquid chromatography apparatus, and may also be supplied to the ejection cavity at a rate of from 1 nl per minute to 2 ml per minute, from 10 nl per minute to 5000 nl per minute, or from 50 nl per minute to 2000 nl per minute.

### BRIEF DESCRIPTION OF THE DRAWINGS

Embodiments of the invention will now be described with reference to the drawings in which:

FIG. 1 is a schematic drawing illustrating an apparatus according to a first preferred embodiment of the invention;

FIG. 2 is a schematic drawing illustrating an apparatus according to a second preferred embodiment of the invention; and

FIG. 3 is a schematic drawing showing a variety of actuators which may be used in the present apparatus.

### DETAILED DESCRIPTION OF THE PREFERRED EMBODIMENTS

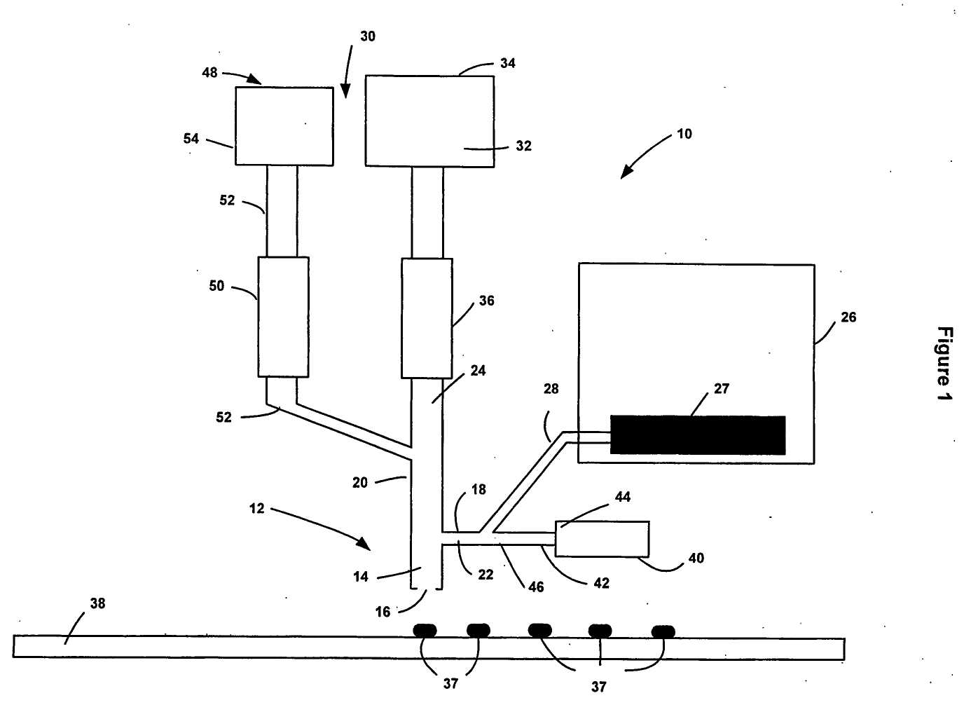

FIG. 1 illustrates an apparatus 10 for dispensing fractions of an analyte solution, according to the first preferred embodiment of the invention. The apparatus comprises a receiver 12 defining an ejection cavity 14 and a circular outlet 16, which is 50 micrometers in diameter downstream of and in fluid communication with the ejection cavity 14. The apparatus further comprises first and second conduits 18, 20 coupled to the receiver 14 and defining respective first and second fluid flow paths 22, 24 in fluid communication with the ejection cavity 14. The apparatus 10 includes an analyte generating apparatus which, in this embodiment, is a liquid chromatography (LC) apparatus 26, including an LC column 27 operatively coupled via LC conduit 28 to the first fluid conduit 18. The LC apparatus is operable to deliver analyte solution in the form of LC fractions along the first fluid flow path 22 to the ejection cavity 14. A dispensing mechanism designated generally by reference numeral 30 is operatively coupled to the second fluid conduit 20 and functions to deliver a fluid buffer 32 along the second fluid flow path 24 into the ejection cavity 14 to displace LC fractions present therein through the outlet 16. In this embodiment, the fluid buffer is a solution consisting of a mixture of water and organic solvents. It would be appreciated that the buffer solution is tailored to the particular application and may contain mild acids, matrix material and other suitable components.

As shown in FIG. 1, the buffer 32 is contained under pressure in a buffer container 34 which is coupled to a solenoid actuator 36, as is known in the art. The solenoid actuator 36 includes a valve (not shown) which can be selectively opened or closed to cause buffer to flow into the ejection cavity 14 to displace an LC fraction 37 present therein onto a collection medium in the form of a steel plate 38.

In this embodiment, the LC fractions are later analyzed using a matrix assisted laser desorption (MALDI) apparatus. Thus, the apparatus 10 includes a matrix flow generator in the form of a syringe pump 40 containing a matrix solution. Alternatives to the syringe pump include any other suitable pump which is effective to supply a flow of matrix to the ejection cavity. The person skilled in the art would understand which materials would be suitable for use as matrices in MALDI applications. Common matrix components include alpha-cyano hydroxy cynnamic acid, 2,5-dehydroxy benzoic acid, sinappinic acid, succinic acid, glycerol, and picolinic acid. The matrix flow generator includes a conduit 42 having a first end 44 in communication with the matrix supply and a second end 46 in communication with the ejection cavity 14. The matrix flow generator 40 is operable to deliver matrix through the matrix conduit 42 to the ejection cavity 14 via the first fluid flow path 22, whereby a mixture of the analyte solution and matrix is formed upstream of the ejection cavity 14 and enters the ejection cavity 14. The mixture is then dispensed when the dispensing mechanism 30 is actuated.

In this embodiment, the dispensing mechanism 30 comprises an aspirator 48 which is selectively operable to reverse the flow of buffer solution 32 from and out of the ejection cavity 14 and upstream along the second fluid conduit 20. The aspiration is effected by a second solenoid actuator 50, as is also known in the art. When the second actuator 50 is actuated, the buffer solution 32 flows into a waste conduit 52 from the second fluid conduit 20 and into a waste reservoir in the form of a waste container 5 containing waste buffer solution. In this embodiment, the waste container 54 has an internal pressure of from 0 to 15 psi.

In use, the liquid chromatography apparatus 26 delivers LC fractions eluted from the LC column through the LC conduit 28 to the ejection cavity 14 via the first fluid flow path 22. The solution is delivered at a rate of 100 nl per minute. Matrix solution is dispensed continuously at a similar rate and a mixture of matrix solution and LC fractions arrives at the ejection cavity at a rate of 200 nl per minute. In this embodiment, the ejection cavity has a volume of 20 nl. Since the rate of flow of analyte solution into the ejection cavity 14 is known, and since the volume of the ejection cavity 14 is known, the time within which the ejection cavity 14 is filled with matrix-containing analyte solution can be easily determined. The apparatus 10 includes a timer which is used to actuate the dispensing mechanism 30 to cause buffer solution to flow into the ejection cavity at select intervals to dispense the analyte solution after the ejection cavity 14 is filled. The buffer solution serves to clean the ejection cavity 14 during dispensing so as to prevent cross-contamination of LC fractions being dispensed. Because the outlet 16 does not come in contact with the steel plate 38, the risk of cross-contamination of samples being dispensed is greatly reduced. To make room for the next sample to be dispensed, the second solenoid actuator 50 is actuated after each dispensing operation to aspirate the buffer and cause it to leave the ejection cavity 14. Eluted material flowing from the LC column may then flow into the ejection cavity 14 after exit of the buffer.

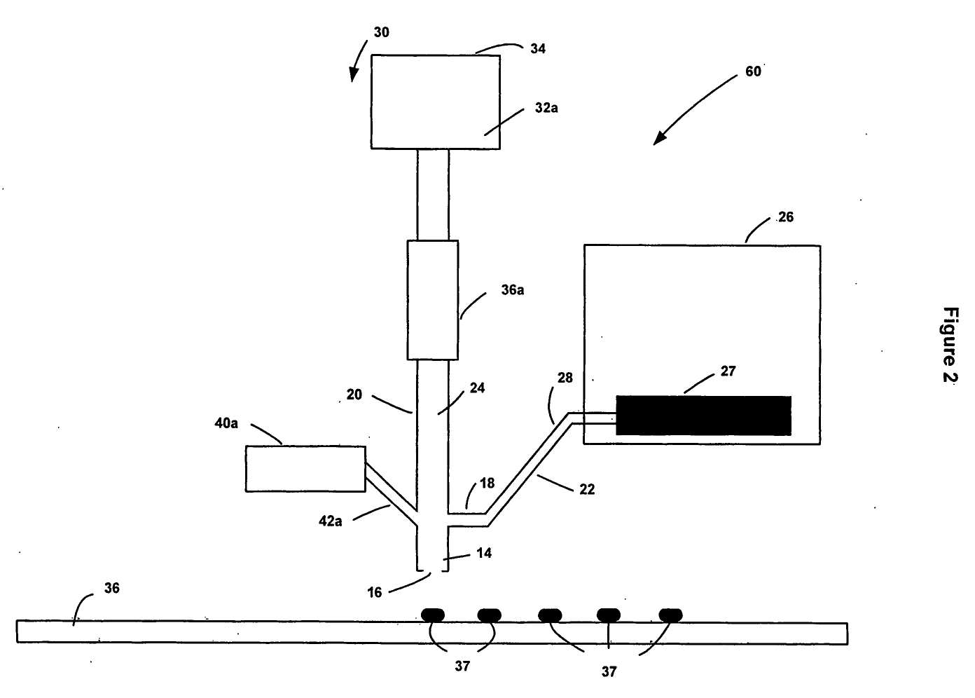

Referring now to FIG. 2, an apparatus 60, according to a second preferred embodiment of the invention, is shown. This embodiment is similar in all respects to the first embodiment described above, and therefore like reference numerals have been used to refer to like parts. One of the differences between this apparatus 60 and the apparatus 10, is that the matrix flow generator 48 is coupled to the ejection cavity 14 downstream of the first fluid conduit 18. In this embodiment, the matrix solution is dispensed through a matrix conduit 42a directly into the ejection cavity 14 whereupon it mixes with an LC fraction present therein. A second difference is that the fluid buffer is gaseous, namely air. Thus, no aspirator is required. The air is contained under pressure in the buffer container 34 and injected into the ejection cavity 14 using a solenoid actuator 36a suitable for use in pneumatic systems, as is known in the art. The solenoid actuator 36a works to apply a pulse of air into the ejection cavity 14 thereby dispensing analyte solution present therein onto the steel plate 38 while, at the same time, cleaning the inside surface of the ejection cavity 14 so as to prevent cross-contamination of analyte fractions being dispensed.

While specific embodiments have been described, the person skilled in the art will appreciate that many modifications may be made to the present invention. For example, the ejection cavity 14 may have a volume of anywhere between 0.1 and 1000 nl, less than 500 nl, less than 200 nl, or less than 100 nl.

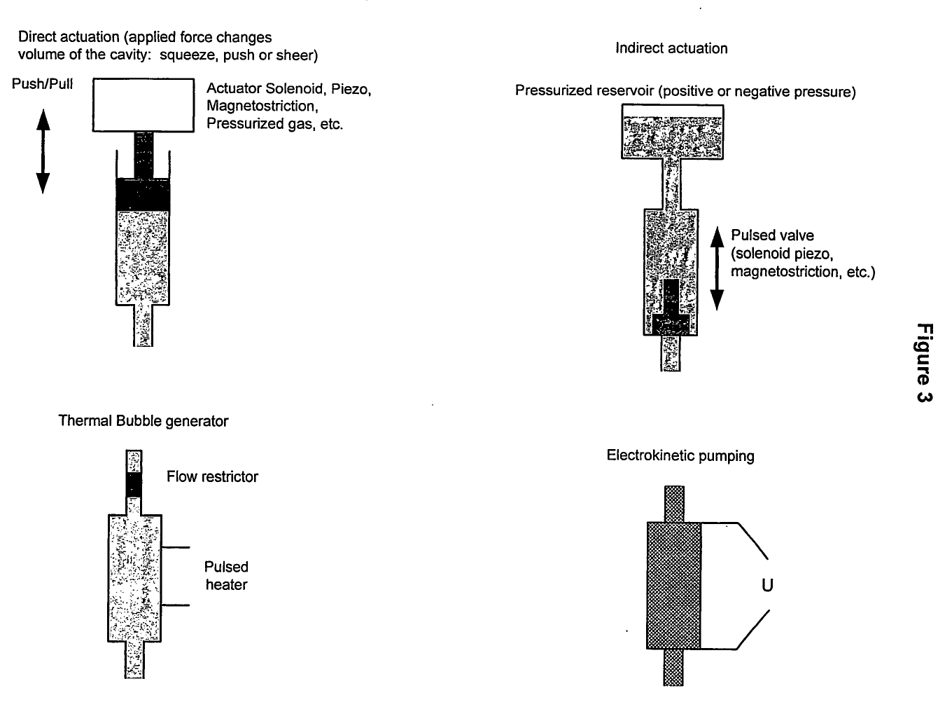

Furthermore, the dispensing mechanism may be any one of a number of direct or indirect actuators, some of which are shown in FIG. 3. Thus, the actuator may be a piezoelectric, electro kinetic, mechanical, valve, thermal, magnetic, or a pressurized gas actuator.

Instead of a liquid chromatography apparatus, any apparatus which operates to generate analyte solution to be dispensed may be used, including capillary electrophoresis and capillary electro chromatography apparatus. It will be appreciated that the present apparatus may be used to dispense low volume samples of any test solution.

In the above examples, buffer is injected into the ejection cavity 14 once the ejection cavity is filled with analyte solution. However, buffer may be injected prior to the ejection cavity 14 being filled completely to dispense volumes less than the internal volume of the ejection cavity. It will also be appreciated that an analyte solution may be supplied to the ejection cavity 14 at varying rates. Typically, solution will be supplied at a rate of from 1 nl per minute to 2 ml per minute. The typical rate of flow of eluted material out of the liquid chromatography apparatus is between 50 nl/min and 1 ml/min and often between 50 nl/min and 5000 nl/min for nano/micro LC applications. Furthermore, any non-reactive gas may be used as the gaseous buffer, including nitrogen, argon and helium.

The aspiration portion of the dispensing mechanism 30 is optional even in the case in which the buffer is a liquid. For example, the pressure generator may be selected and configured to inject only enough buffer so as to displace an amount of analyte solution equivalent to the volume of the meniscus of analyte solution forming at the outlet. In this case, the ejection cavity 14 would still contain mostly analyte solution after each dispensing operation and there would be no need to aspirate the buffer to make room for analyte solution entering the ejection cavity 14.

Furthermore, the dispensing and aspiration functions of the dispensing mechanism 30 may be combined in a single device. For example, an electrokinetic pump may be used to cause liquid to flow in opposite directions depending on the polarity of the voltage applied. Thus, when dispensing, the voltage of the pump will be of one polarity, and when aspirating, the voltage will be of the opposite polarity. There are other devices which may be used in place of an electrokinetic pump to achieve this combined function. The person skilled in the art will readily understand which alternative devices would be suitable in the present application.

The foregoing description is by way of example only and shall not be construed so as to the limit the scope of the following claims.

1. An apparatus for dispensing fractions of an analyte solution, the apparatus comprising:
(a) a receiver defining an ejection cavity and an outlet downstream of and in fluid communication with the ejection cavity;
(c) first and second fluid conduits coupled to the receiver and defining respective first and second fluid flow paths in fluid communication with the ejection cavity;
(c) an analyte generating apparatus operatively coupled to the first fluid conduit and operable to deliver analyte solution along the first fluid flow path to the ejection cavity;
(d) a dispensing mechanism operatively coupled to the second fluid conduit and operable to deliver a fluid buffer along the second fluid flow path into the ejection cavity to displace analyte solution present therein through the outlet.

2. The apparatus of claim 1, wherein the ejection cavity has a volume of between 0.1 nl and 1000 nl.

3. The apparatus of claim 2, wherein the ejection cavity has a volume less than 500 nl.

4. The apparatus of claim 3, wherein the ejection cavity has a volume less than 200 nl.

5. The apparatus of claim 4, wherein the ejection cavity has a volume less than 100 nl.

6. The apparatus of claim 1, wherein the dispensing mechanism comprises an actuator chosen from solenoid, piezoelectric, electro kinetic, mechanical, valve, thermal, magnetic, and pressurized fluid actuators.

7. The apparatus of claim 6, wherein the dispensing mechanism comprises a solenoid actuator.

8. The apparatus of claim 1, wherein the analyte generating apparatus comprises a component chosen from liquid chromatography, capillary electrophoresis, capillary electro chromatography apparatus and sample injection apparatus.

9. The apparatus of claim 8, wherein the analyte generating apparatus comprises a liquid chromatography apparatus.

10. The apparatus of claim 1 for use in dispensing fractions of an analyte solution onto a collection medium for subsequent testing by matrix assisted laser desorption ionization, the apparatus comprising a matrix flow generator, the matrix flow generator having a matrix supply and a third conduit having a first end in communication with the matrix supply and a second end in communication with the ejection cavity, the matrix flow generator being operable to deliver matrix through the third conduit to the ejection cavity, whereby a mixture of the analyte solution and matrix is dispensed when the dispensing mechanism is actuated.

11. The apparatus of claim 10, wherein the second end of the third conduit is in communication with the first flow path upstream of the ejection cavity.

12. The apparatus of claim 1, wherein the dispensing mechanism comprises an aspirator selectively operable to reverse the flow of buffer from and out of the ejection cavity and upstream along the second fluid conduit.

13. The apparatus of claim 1, wherein the opening is circular and has a diameter of from 5 to 200 micrometers

14. The apparatus of claim 13, wherein the opening has a diameter of less than 100 micrometers.

15. The apparatus of claim 14, wherein the opening has a diameter of less than 50 micrometers.

16. The apparatus of claim 13, wherein the opening has a diameter of less than 20 micrometers.

17. A method for dispensing fractions of an analyte solution comprising the steps of:
(a) providing a receiver defining an ejection cavity and an outlet in communication with and downstream of the ejection cavity;
(d) filling the ejection cavity with an analyte solution at a selected rate; and
(e) injecting a fluid buffer into the ejection cavity to displace the analyte solution through the outlet, when or before the ejection cavity is full of analyte solution.

18. The method of claim 17, wherein the ejection cavity has a volume of from 0.1 nl to 1000 nl.

19. The method of claim 18, wherein the ejection cavity has a volume less than 500 nl.

20. The method of claim 19, wherein the ejection cavity has a volume less than 200 nl.

21. The method of claim 20, wherein the ejection cavity has a volume less than 100 nl.

22. The method of claim 21, wherein the ejection cavity has a volume less than 50 nl.

23. The method of claim 17, wherein the buffer is a gas.

24. The method of claim 17, wherein the buffer is a liquid.

25. The method of claim 17, wherein the analyte solution is eluted material exiting a liquid chromatography apparatus.

26. The method of claim 17, wherein the analyte solution is supplied to the ejection cavity at a rate of from 1 nl per minute to 2 ml per minute.

27. The method of claim 26, wherein the analyte solution is supplied to the ejection cavity at a rate of from 10 nl per minute to 5000 nl per minute.

28. The method of claim 27, wherein the analyte solution is supplied to the ejection cavity at a rate of from 50 nl per minute to 2000 nl per minute.
